(19) United States
(12) Patent Application Publication
(10) Pub. No.: US 2022/0058895 A1
(43) Pub. Date: Feb. 24, 2022

(54) APPARATUS AND METHOD FOR ADJUSTING CONFIDENCE LEVEL OF OUTPUT OF SENSOR

(71) Applicants: Hyundai Motor Company, Seoul (KR); Kia Corporation, Seoul (KR)

(72) Inventor: Seul Ki HAN, Seoul (KR)

(73) Assignees: Hyundai Motor Company, Seoul (KR); Kia Corporation, Seoul (KR)

(21) Appl. No.: 17/401,022

(22) Filed: Aug. 12, 2021

(30) Foreign Application Priority Data
Aug. 20, 2020 (KR) 10-2020-0104408

(51) Int. Cl. G07C 5/08; G01S 13/931; G01S 7/40

(52) U.S. Cl. CPC G07C 5/0808; G01S 7/40; G01S 13/931

(57) ABSTRACT

A sensor output confidence level adjustment apparatus includes a sensor information acquisition unit configured to acquire information on different types of sensors, a sensor consistency determination unit configured to determine consistency between the different types of sensors according to the information on the different types of sensors, a driving environment determination unit configured to determine a driving environment of a vehicle when the consistency between the different types of sensors is lower than a reference value, and a confidence level adjustment unit configured to adjust confidence levels of the different types of sensors according to the consistency between the different types of sensors and the driving environment and to readjust the confidence levels of the different types of sensors according to the adjusted confidence levels.

The present application claims priority to Korean Patent Application No. 10-2020-0104408, filed on Aug. 20, 2020, the entire contents of which is incorporated herein for all purposes by this reference.

### BACKGROUND OF THE INVENTION

### Field of the Invention

The present invention relates to an apparatus of adjusting the confidence level of an output of a sensor, and more particularly to an apparatus and method for adjusting the confidence level of an output of a sensor using contextual information.

### Description of Related Art

Recently developed vehicular sensors provide not only information on the physical status of an object to be detected, for example the location and the speed of the object, but also information indicating the statuses of outputs of the sensors.

For example, information indicating the status of an output of a sensor may include an age, which indicates how much time has elapsed after generation of the output of the sensor, a status, which indicates whether the output has been generated through estimation based on a movement model established in advance without actually measuring the object or has been generated by actually measuring the object, and a confidence level, which is adjusted in consideration of various factors.

The confidence level is one of the most important pieces of information because it is directly associated with a determination as to whether to use an output of a sensor.

Sensor manufacturers design output information in different methods. In general, however, a confidence level is designed to indicate reliability, validity, and association of an output of a sensor.

In general, vehicle manufacturers that use sensor output information use sensor output information within limits related to a confidence level thereof.

In some cases, however, although the accuracy of the sensor output is high, the suitability thereof for a system using the same may be low.

Therefore, there is demand for the development of an apparatus of adjusting the confidence level of an output of a sensor using contextual information to increase the accuracy of the output of the sensor and the suitability for a system using the same.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an apparatus and method for adjusting the confidence level of an output of a sensor that substantially obviate one or more problems due to limitations and disadvantages of the related art.

Embodiments provide an apparatus and method for adjusting the confidence level of an output of a sensor that are configured for readjusting the confidence levels of different types of sensors based on consistency between the different types of sensors and the driving environment of a vehicle, improving the performance and stability of a sensor fusion system.

However, the objects to be accomplished by the exemplary embodiments are not limited to the above-mentioned objects, and other objects not mentioned herein will be clearly understood by those skilled in the art from the following description.

To accomplish the above and other objects, a sensor output confidence level adjustment apparatus according to various exemplary embodiments of the present invention may include a sensor information acquisition unit configured to acquire information on different types of sensors, a sensor consistency determination unit configured to determine consistency between the different types of sensors according to the information on the different types of sensors, a driving environment determination unit configured to determine a driving environment of a vehicle when the consistency between the different types of sensors is lower than a reference value, and a confidence level adjustment unit configured to determine suitability of confidence levels of the different types of sensors according to the consistency between the different types of sensors and the driving environment and to readjust the confidence levels of the different types of sensors based thereon.

Furthermore, a sensor output confidence level adjustment method according to various exemplary embodiments of the present invention is a method of determining validity of the confidence level of an output of a sensor of a sensor output confidence level adjustment apparatus including a sensor information acquisition unit, a sensor consistency determination unit, a driving environment determination unit, and a confidence level adjustment unit. The sensor output confidence level adjustment method may include acquiring, by the sensor information acquisition unit, information on different types of sensors, determining, by the sensor consistency determination unit, consistency between the different types of sensors according to the information on the different types of sensors, determining, by the driving environment determination unit, a driving environment when the consistency between the different types of sensors is lower than a reference value, and determining, by the confidence level adjustment unit, suitability of confidence levels of the different types of sensors according to the consistency between the different types of sensors and the driving environment and readjusting the confidence levels of the different types of sensors based thereon.

Furthermore, a computer-readable recording medium according to various exemplary embodiments of the present invention, in which a program for executing a sensor output confidence level adjustment method of a sensor output confidence level adjustment apparatus is recorded, may perform a process provided in the sensor output confidence level adjustment method of the sensor output confidence level adjustment apparatus.

Furthermore, a vehicle according to various exemplary embodiments of the present invention may include different types of sensors, configured to detect a driving environment of the vehicle, and a sensor output confidence level adjustment apparatus, configured to determine suitability of confidence levels of the different types of sensors and to readjust the confidence levels of the different types of sensors based thereon, wherein the sensor output confidence level adjustment apparatus may acquire information on the different types of sensors, may determine consistency between the different types of sensors according to the information on the different types of sensors, may determine the driving environment when the consistency between the different types of sensors is lower than a reference value, may determine suitability of the confidence levels of the different types of sensors based on the consistency between the different types of sensors and the driving environment, and may readjust the confidence levels of the different types of sensors based thereon.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram showing a vehicle including a sensor output confidence level adjustment apparatus according to various exemplary embodiments of the present invention;

FIG. 2 is a block diagram showing the configuration of the sensor output confidence level adjustment apparatus according to various exemplary embodiments of the present invention;

FIG. 3 is a flowchart showing a sensor output confidence level adjustment method according to various exemplary embodiments of the present invention; and

FIG. 4 and FIG. 5 are diagrams showing a process of adjusting a confidence level according to a driving environment of a vehicle.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, embodiments will be described in detail with reference to the accompanying drawings so that those skilled in the art may easily carry out the embodiments. The embodiments may, however, be embodied in many different forms, and may not be construed as being limited to the embodiments set forth herein. In the drawings, portions irrelevant to the description of the present invention will be omitted for clarity. Like reference numerals refer to like elements throughout the specification.

Throughout the specification, when a certain part “includes” or “comprises” a certain component, this indicates that other components are not excluded, and may be further included unless otherwise noted. The terms “-part”, “-unit”, and “-module” used in the specification mean units for processing at least one function or operation, and can be implemented as hardware components, software components, or combinations of hardware components and software components.

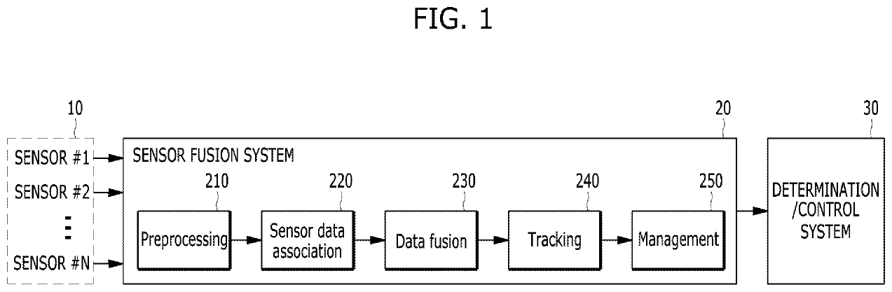

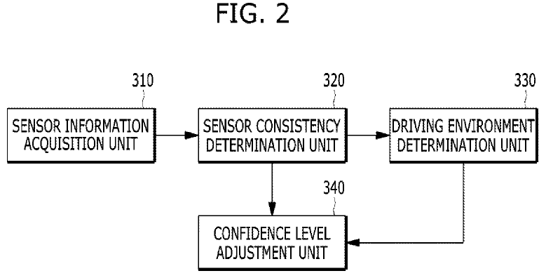

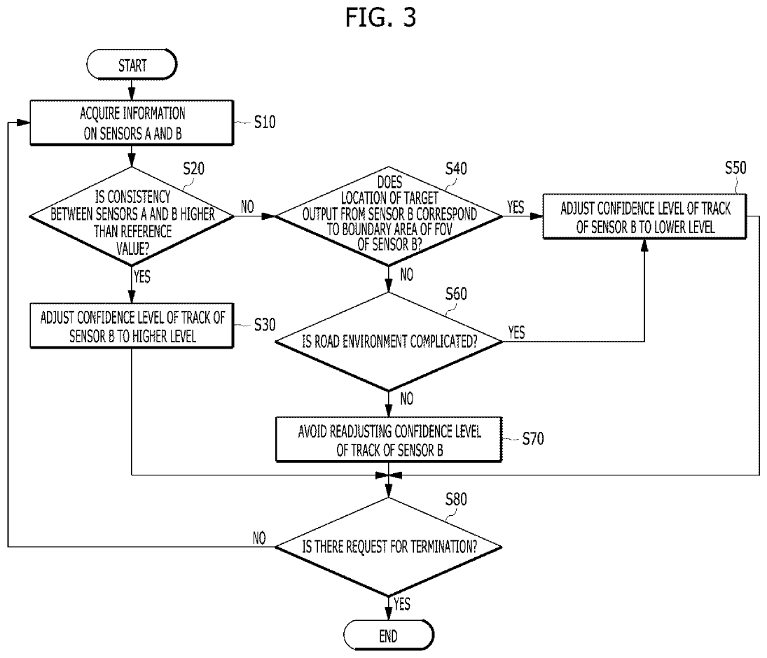

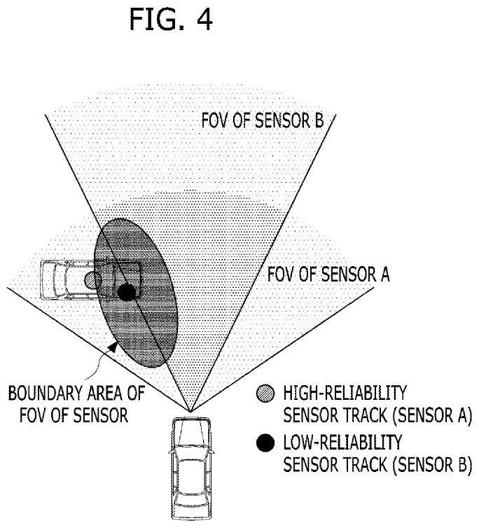

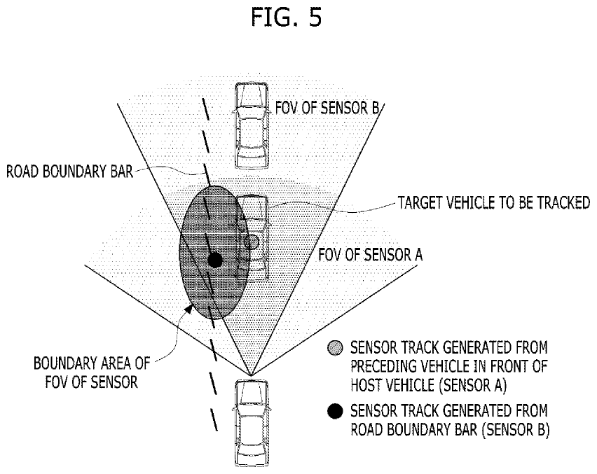

Hereinafter, an apparatus and method for adjusting the confidence level of an output of a sensor that are applicable to exemplary embodiments will be described in detail with reference to FIG. 1, FIG. 2, FIG. 3, FIG. 4, and FIG. 5.

FIG. 1 is a diagram showing a vehicle including a sensor output confidence level adjustment apparatus according to various exemplary embodiments of the present invention.

As shown in FIG. 1, the vehicle may include different types of sensors 10, which detect the driving environment of the vehicle, a sensor fusion system 20, and a determination and control system 30.

Here, the sensor output confidence level adjustment apparatus according to the exemplary embodiment may be applied to the sensor fusion system 20, which is necessarily required to implement a driver assistance system and an autonomous driving system.

The sensor fusion system 20 may include a preprocessing unit 210, a sensor data association unit 220, a data fusion unit 230, a tracking unit 240, and a management unit 250.

In the instant case, the sensor output confidence level adjustment apparatus according to the exemplary embodiment may be applied to the preprocessing unit 210, which performs reprocessing and redefinition on information output from the sensor.

Accordingly, the sensor output confidence level adjustment apparatus according to the exemplary embodiment may perform readjustment on a confidence level of the output of the sensor, which is one of inputs to the sensor fusion system, improving the performance and stability of the sensor fusion system.

According to the exemplary embodiment of the present invention, when a plurality of sensors simultaneously detects the same object, the confidence level of the output of each sensor may be readjusted in consideration of the fact that the positions, speeds, and output confidence levels of the sensor tracks are different.

Here, the difference in the outputs of the sensors is caused not only by a difference in the performance and characteristics of the sensors but also by contextual information depending on the driving environment and situation of the vehicle, so it is possible to correct the confidence level information on the outputs of the sensors based thereon.

In the instant case, the sensor track may include kinetic information related to an object which is detected by the sensor, for example, the location and the speed of the object, and various other pieces of information. The other pieces of information may include classification of an object, which is performed by the sensor, an age of a track, and a confidence level.

The sensor output confidence level adjustment apparatus according to the exemplary embodiment may acquire information on the different types of sensors, and may determine consistency between the different types of sensors based on the information on the different types of sensors. Furthermore, when the consistency between the different types of sensors is lower than a reference value, the sensor output confidence level adjustment apparatus according to the exemplary embodiment may determine the driving environment of the vehicle, may determine suitability of the confidence levels of the different types of sensors based on the consistency between the different types of sensors and the driving environment of the vehicle, and may readjust the confidence levels of the different types of sensors based thereon.

According to the exemplary embodiment of the present invention, the sensors may be classified into a high-reliability sensor and a low-reliability sensor based on information which may be acquired in advance, such as a recognition accuracy tendency and a recognition area, depending on the type of sensor and the driving environment and situation of the vehicle.

As for the recognition accuracy tendency depending on the type of sensor, for example, a camera may exhibit high accuracy of detection of a horizontal position and low accuracy of detection of a vertical position, and may be sensitive to luminance, compared to a RaDAR sensor.

The recognition area may depend on the specifications and mounting position of a sensor. The driving environment and situation of the vehicle may be information related to the curvature of a road, a target, the heading of a host vehicle, and the like.

According to the exemplary embodiment of the present invention, some of the pieces of information on the low-reliability sensor may be redefined based on the consistency with the high-reliability sensor.

According to the exemplary embodiment of the present invention, the consistency between the sensors may be determined based on position and speed information as expressed using the following equations.

$${( {y}_{k}^{s 1} - {y}_{k}^{s 1} )}^{T} {R}^{- 1} ( {y}_{k}^{s 1} - {y}_{k}^{s 1} ) \leq γ$$

$$where {y}_{k}^{s 1} = [ \begin{matrix}{x}^{s 1} \\ {y}^{s 1} \\ {\dot{x}}^{s 1} \\ {\dot{y}}^{s 1}\end{matrix} ] , {y}_{k}^{s 2} = [ \begin{matrix}{x}^{s 2} \\ {y}^{s 2} \\ {\dot{x}}^{s 2} \\ {\dot{y}}^{s 2}\end{matrix} ] , {R}^{- 1} = [ \begin{matrix}{σ}_{x}^{2} & 0 & 0 & 0 \\ 0 & {σ}_{y}^{2} & 0 & 0 \\ 0 & 0 & {σ}_{\dot{x}}^{2} & 0 \\ 0 & 0 & 0 & {σ}_{\dot{y}}^{2}\end{matrix} ]$$

$$\frac{{( {x}^{s 1} - {x}^{s 2} )}^{2}}{{σ}_{x}^{2}} + \frac{{( {y}^{s 1} - {y}^{s 2} )}^{2}}{{σ}_{y}^{2}} + \frac{{( {\dot{x}}^{s 1} - {\dot{x}}^{s 2} )}^{2}}{{σ}_{\dot{x}}^{2}} + \frac{{( {\dot{y}}^{s 1} - {\dot{y}}^{s 2} )}^{2}}{{σ}_{\dot{y}}^{2}} \leq γ$$

Here, yₖ^{X} represents a vector of a measurement value at a time point k of a sensor X, {x^{X}, y^{X}} and {\dot{x}^{X}, \dot{y}^{X}} represent the vertical and horizontal positions and the vertical and horizontal speeds of a target object relative to the sensor mounted in the host vehicle, and {σₓ, σ_{y}, σ_{\dot{x}}, σ_{\dot{y}}} represent standard deviations of errors in the positions and the speeds γ represents a design variable, which may be determined from a p-value of a chi-square distribution.

The above equations are generally used to determine the correlation between an estimate and a measurement in a data association method. In the exemplary embodiment of the present invention, the above equations may be used to determine consistency between the different types of sensors.

For example, according to the exemplary embodiment of the present invention, when the high-reliability sensor is denoted by “A” and the low-reliability sensor is denoted by “B”, the confidence level of the output of the sensor B may be readjusted according to the consistency between the sensor A and the sensor B.

The exemplary embodiment may also consider the following cases.

In both of a first case, in which the consistency of the position/speed between the sensor A and the sensor B is high, and a second case, in which the consistency of the position/speed between the sensor A and the sensor B is low, since the sensor A is assumed to be a high-reliability sensor, the confidence level of the output of the sensor A may have a sufficiently high value.

In the first case, in which the consistency of physical information between the two sensors is high, the confidence level of the output of the sensor B may be readjusted to the same level as that of the sensor A.

In the second case, in which the consistency of physical information between the two sensors is low, whether the vehicle is in a driving state in which the output of the sensor B is unreliable is determined. In the state in which the output of the sensor B is unreliable, the confidence level of the output of the sensor B may be lowered to prevent the information on the sensor B from being actively used.

The above cases may be summarized using the following equations.

The first case may be expressed as follows.

$$\frac{{( {x}^{A} - {x}^{B} )}^{2}}{{σ}_{x}^{2}} + \frac{{( {y}^{A} - {y}^{B} )}^{2}}{{σ}_{y}^{2}} + \frac{{( {\dot{x}}^{A} - {\dot{x}}^{B} )}^{2}}{{σ}_{\dot{x}}^{2}} + \frac{{( {\dot{y}}^{A} - {\dot{y}}^{B} )}^{2}}{{σ}_{\dot{y}}^{2}} \leq γ , then ConfLv ( B ) = ConfLv ( A )$$

The second case may be expressed as follows.

$$\frac{{( {x}^{A} - {x}^{B} )}^{2}}{{σ}_{x}^{2}} + \frac{{( {y}^{A} - {y}^{B} )}^{2}}{{σ}_{y}^{2}} + \frac{{( {\dot{x}}^{A} - {\dot{x}}^{B} )}^{2}}{{σ}_{\dot{x}}^{2}} + \frac{{( {\dot{y}}^{A} - {\dot{y}}^{B} )}^{2}}{{σ}_{\dot{y}}^{2}} > γ , then ConfLv ( B ) where 0 < α < 1$$

Here, ConfLv(X) represents confidence level information on a sensor X, and may be defined to have a value from 0 to 1.

Furthermore, in the exemplary embodiment of the present invention, the following conditions may be considered representatively to determine whether the vehicle is in a driving state in which the output of the sensor is unreliable.

The conditions to be considered may include a first condition of determining whether the location of the target output from the low-reliability sensor corresponds to the boundary area of the field of view (FOV) of the low-reliability sensor, a second condition of determining the degree of curvature of a road, a third condition of determining the heading, in degrees, of each of the target and the host vehicle, and a fourth condition of determining whether an obstacle or a curb is present on a road. For the second case to be validated, the above conditions need to be considered together.

FIG. 2 is a block diagram showing the configuration of the sensor output confidence level adjustment apparatus according to various exemplary embodiments of the present invention.

As shown in FIG. 2, the sensor output confidence level adjustment apparatus according to various exemplary embodiments of the present invention may include a sensor information acquisition unit 310 for acquiring information on the different types of sensors, a sensor consistency determination unit 320 for determining the consistency between the different types of sensors according to the information on the different types of sensors, a driving environment determination unit 330 for determining a driving environment when the consistency between the different types of sensors is lower than a reference value, and a confidence level adjustment unit 340 for determining whether the confidence levels of the different types of sensors are suitable based on the consistency between the different types of sensors and the driving environment and for readjusting the confidence levels of the different types of sensors based thereon.

Here, the sensor consistency determination unit 320 may classify the reliabilities of the different types of sensors according to the information on the different types of sensors, which includes a recognition accuracy tendency and a recognition area depending on the type of sensor and the driving environment and situation of the vehicle, and may determine the consistency between the different types of sensors.

For example, the sensor consistency determination unit 320 may determine the recognition accuracy tendency in consideration of accuracy of detection of a horizontal position, accuracy of detection of a vertical position, and sensitivity to luminance depending on the type of sensor, may determine the recognition area in consideration of the specifications and mounting position of each sensor, and may determine the driving environment and situation of the vehicle in consideration of the curvature of a road, a target, and the heading of the host vehicle.

Furthermore, when determining the consistency between the different types of sensors, the sensor consistency determination unit 320 may classify the relative reliabilities of the different types of sensors based on the information on the different types of sensors, and may determine the consistency between the high-reliability sensor and the low-reliability sensor.

Furthermore, when determining the consistency between the different types of sensors, the sensor consistency determination unit 320 may determine the consistency between the different types of sensors based on location and speed information of a target.

Here, the sensor consistency determination unit 320 may determine the consistency between the different types of sensors as expressed using the following equations.

$${( {y}_{k}^{s 1} - {y}_{k}^{s 1} )}^{T} {R}^{- 1} ( {y}_{k}^{s 1} - {y}_{k}^{s 1} ) \leq γ$$

$$where {y}_{k}^{s 1} = [ \begin{matrix}{x}^{s 1} \\ {y}^{s 1} \\ {\dot{x}}^{s 1} \\ {\dot{y}}^{s 1}\end{matrix} ] , {y}_{k}^{s 2} = [ \begin{matrix}{x}^{s 2} \\ {y}^{s 2} \\ {\dot{x}}^{s 2} \\ {\dot{y}}^{s 2}\end{matrix} ] , {R}^{- 1} = [ \begin{matrix}{σ}_{x}^{2} & 0 & 0 & 0 \\ 0 & {σ}_{y}^{2} & 0 & 0 \\ 0 & 0 & {σ}_{\dot{x}}^{2} & 0 \\ 0 & 0 & 0 & {σ}_{\dot{y}}^{2}\end{matrix} ]$$

$$\frac{{( {x}^{s 1} - {x}^{s 2} )}^{2}}{{σ}_{x}^{2}} + \frac{{( {y}^{s 1} - {y}^{s 2} )}^{2}}{{σ}_{y}^{2}} + \frac{{( {\dot{x}}^{s 1} - {\dot{x}}^{s 2} )}^{2}}{{σ}_{\dot{x}}^{2}} + \frac{{( {\dot{y}}^{s 1} - {\dot{y}}^{s 2} )}^{2}}{{σ}_{\dot{y}}^{2}} \leq γ$$

Here, yₖ^{X} represents a vector of a measurement value at a time point k of a sensor X, {x^{X}, y^{X}} and {\dot{x}^{X}, \dot{y}^{X}} represent the vertical and horizontal positions and the vertical and horizontal speeds of a target object relative to the sensor mounted in the host vehicle, {σₓ, σ_{y}, σ_{\dot{x}}, σ_{\dot{y}}} represent standard deviations of errors in the positions and the speeds, and γ represents a design variable.

Subsequently, when the consistency between the different types of sensors is lower than a reference value, the driving environment determination unit 330 may determine the driving environment of the vehicle based on preset conditions.

Here, the driving environment determination unit 330 may determine the driving environment based on a first condition of determining whether the location of the target output from the low-reliability sensor corresponds to the boundary area of the field of view (FOV) of the low-reliability sensor, a second condition of determining the degree of curvature of a road, a third condition of determining the heading, in degrees, of each of the target and the host vehicle, and a fourth condition of determining whether an obstacle or a curb is present on a road.

Subsequently, when the consistency between the different types of sensors is higher than the reference value, the confidence level adjustment unit 340 may readjust the confidence level of the output of the low-reliability sensor to the same level as that of the high-reliability sensor.

The readjustment of the confidence level of the output of the low-reliability sensor to the same level as that of the high-reliability sensor by the confidence level adjustment unit 340 may be expressed using the following equation.

$$\frac{{( {x}^{A} - {x}^{B} )}^{2}}{{σ}_{x}^{2}} + \frac{{( {y}^{A} - {y}^{B} )}^{2}}{{σ}_{y}^{2}} + \frac{{( {\dot{x}}^{A} - {\dot{x}}^{B} )}^{2}}{{σ}_{\dot{x}}^{2}} + \frac{{( {\dot{y}}^{A} - {\dot{y}}^{B} )}^{2}}{{σ}_{\dot{y}}^{2}} \leq γ , then ConfLv ( B ) = ConfLv ( A )$$

Here, ConfLv(X) represents confidence level information on a sensor X, and has a value from 0 to 1.

The above equation indicates that the sensor A is the high-reliability sensor and that the confidence level ConfLv(B) of the sensor B is redefined using the confidence level ConfLv(A) of the sensor A.

Furthermore, when the driving environment determination unit 330 determines that the location of the target output from the low-reliability sensor corresponds to the boundary area of the field of view (FOV) of the low-reliability sensor, the confidence level adjustment unit 340 may readjust the confidence level of the output of the low-reliability sensor to a lower level.

The readjustment of the confidence level of the output of the low-reliability sensor to a lower level by the confidence level adjustment unit 340 may be expressed using the following equation.

$$\frac{{( {x}^{A} - {x}^{B} )}^{2}}{{σ}_{x}^{2}} + \frac{{( {y}^{A} - {y}^{B} )}^{2}}{{σ}_{y}^{2}} + \frac{{( {\dot{x}}^{A} - {\dot{x}}^{B} )}^{2}}{{σ}_{\dot{x}}^{2}} + \frac{{( {\dot{y}}^{A} - {\dot{y}}^{B} )}^{2}}{{σ}_{\dot{y}}^{2}} > γ ,$$

then ConfLv(B)=α·ConfLv(B) where 0<α<1

Here, ConfLv(X) represents confidence level information on a sensor X, and has a value from 0 to 1.

Subsequently, when the driving environment determination unit 330 determines that the location of the target output from the low-reliability sensor does not correspond to the boundary area of the field of view (FOV) of the low-reliability sensor and that the road environment is complicated, the confidence level adjustment unit 340 may readjust the confidence level of the output of the low-reliability sensor to a lower level. Here, the driving environment determination unit 330 may determine whether the road environment is complicated or not, based on the number of surrounding vehicles and/or road obstacles (e.g., traffic cones, road stoppers, blocking rods, etc.) detected by the different types of sensors. For example, when the number of surrounding vehicles detected by the different types of sensors exceeds a predetermined number, the driving environment determination unit 330 may determine that the road environment is complicated.

When the driving environment determination unit 330 determines that the location of the target output from the low-reliability sensor does not correspond to the boundary area of the field of view (FOV) of the low-reliability sensor and that the road environment is not complicated, the confidence level adjustment unit 340 may not readjust the confidence level of the output of the low-reliability sensor.

As described above, according to the exemplary embodiment of the present invention, the validity of the confidence levels of the different types of sensors is determined based on the consistency between the different types of sensors and the driving environment of the vehicle, and the confidence levels of the different types of sensors are readjusted based thereon, making it possible to improve the performance and stability of the sensor fusion system.

FIG. 3 is a flowchart showing a sensor output confidence level adjustment method according to various exemplary embodiments of the present invention.

As shown in FIG. 3, according to the exemplary embodiment of the present invention, information on the different types of sensors A and B may be acquired (S10).

Here, it is assumed that the reliability of the sensor A is higher than the reliability of the sensor B.

Subsequently, according to the exemplary embodiment of the present invention, whether consistency between the different types of sensors A and B is higher than a reference value may be determined based on the information on the different types of sensors A and B (S20).

Here, according to the exemplary embodiment of the present invention, the reliabilities of the different types of sensors may be classified based on the information on the different types of sensors, which includes a recognition accuracy tendency and a recognition area depending on the type of sensor and the driving environment and situation of the vehicle, and the consistency between the different types of sensors may be determined.

For example, according to the exemplary embodiment of the present invention, the recognition accuracy tendency may be determined in consideration of accuracy of detection of a horizontal position, accuracy of detection of a perpendicular position, and sensitivity to luminance depending on the type of sensor, the recognition area may be determined in consideration of the specifications and mounting position of each sensor, and the driving environment and situation of the vehicle may be determined in consideration of the curvature of a road, a target, and the heading of the host vehicle.

Furthermore, according to the exemplary embodiment of the present invention, the relative reliabilities of the different types of sensors may be classified based on the information on the different types of sensors, and the consistency between the high-reliability sensor and the low-reliability sensor may be determined.

Subsequently, according to the exemplary embodiment of the present invention, when the consistency between the different types of sensors is higher than the reference value, the confidence level of the output of the low-reliability sensor B may be readjusted to be increased to the same level as that of the high-reliability sensor A (S30).

On the other hand, when the consistency between the different types of sensors is lower than the reference value, whether the location of the target output from the low-reliability sensor B, among the driving environment factors, corresponds to the boundary area of the field of view (FOV) of the low-reliability sensor B is determined (S40).

Subsequently, according to the exemplary embodiment of the present invention, among the driving environment factors, when the location of the target output from the low-reliability sensor B corresponds to the boundary area of the field of view (FOV) of the low-reliability sensor B, the confidence level of the output of the low-reliability sensor B may be readjusted to a lower level (S50).

According to the exemplary embodiment of the present invention, among the driving environment factors, when the location of the target output from the low-reliability sensor B does not correspond to the boundary area of the field of view (FOV) of the low-reliability sensor B, whether the road environment is complicated is determined (S60).

Subsequently, according to the exemplary embodiment of the present invention, when it is determined that the road environment is complicated, the confidence level of the output of the low-reliability sensor B may be readjusted to a lower level (S50).

On the other hand, when it is determined that the road environment is not complicated, the confidence level of the output of the low-reliability sensor B may not be readjusted (S70).

Subsequently, according to the exemplary embodiment of the present invention, the validity of the confidence levels of the different types of sensors may be determined based on the consistency between the different types of sensors and the driving environment of the vehicle, and the confidence levels of the different types of sensors may be readjusted based thereon. Thereafter, whether there is a request for termination may be determined (S80). When there is a request for termination, the above-described process may be terminated.

FIG. 4 and FIG. 5 are diagrams showing a process of adjusting the confidence level according to the driving environment of the vehicle.

FIG. 4 shows the driving environment of the vehicle in which the location of the target output from the sensor B corresponds to the boundary area of the field of view (FOV) of the sensor B.

As shown in FIG. 4, when the two sensors A and B have different respective fields of view (FOVs) and when the target object is located in the boundary area of the field of view (FOV) of the sensor B, the output information on the sensor B may be unreliable.

Therefore, kinetic information such as the location and the speed of the target object, an age, indicating the status of an output of the sensor, and the confidence level of the sensor may also be unreliable.

Accordingly, according to the exemplary embodiment of the present invention, although the information output from the sensor B, such as the location and the speed of the target object, is not adjusted in consideration of the information output from the sensor A, the confidence level of the output of the sensor B may be redefined based on the consistency between the pieces of information output from the sensors A and B.

FIG. 5 shows the situation in which the driving environment of the vehicle is complicated.

As shown in FIG. 5, in a complicated driving environment, it may be assumed that a preceding vehicle to be tracked is traveling in front of the host vehicle at a low speed in an area adjacent to road boundary bars.

In the instant case, a sensor that generates a measurement value based on reflected wave information, such as RaDAR, may generate a measurement value from a road boundary bar which is close to the preceding vehicle.

Although the present information has location and speed values similar to those of the target vehicle, which is traveling at a low speed, and is highly reliable because it is generated from the actual object, it may not be used to track a preceding vehicle.

In a place in which the driving environment is complicated, it is necessary to selectively use the information provided by the sensors.

Therefore, according to the exemplary embodiment of the present invention, in the case in which the sensor A reliably outputs information on the location and the speed of the target vehicle, like a camera, even in a complicated driving environment, the confidence level of the sensor B may be readjusted based on the confidence level of the sensor A.

That is, according to the exemplary embodiment of the present invention, a criterion for determining consistency between information on the sensor A and information on another sensor may be set to be more strict so that, when the criterion is not satisfied, the confidence level of the other sensor is readjusted to a lower level and is not used.

As described above, according to the exemplary embodiment of the present invention, the validity of the confidence levels of the different types of sensors is determined based on the consistency between the different types of sensors and the driving environment of the vehicle, and the confidence levels of the different types of sensors are readjusted based thereon, making it possible to improve the performance and stability of the sensor fusion system.

Meanwhile, the exemplary embodiment provides a computer-readable recording medium in which a program for executing the sensor output confidence level adjustment method of the sensor output confidence level adjustment apparatus is recorded, and the process provided in the sensor output confidence level adjustment method of the sensor output confidence level adjustment apparatus according to the exemplary embodiment may be performed thereby.

The present invention may be implemented as code which may be written on a computer-readable recording medium and thus read by a computer system. The computer-readable recording medium includes all kinds of recording devices in which data which may be read by a computer system are stored. Examples of the computer-readable recording medium include a Hard Disk Drive (HDD), a Solid-State Disk (SSD), a Silicon Disk Drive (SDD), Read-Only Memory (ROM), Random Access Memory (RAM), Compact Disk ROM (CD-ROM), a magnetic tape, a floppy disc, and an optical data storage.

As is apparent from the above description, the apparatus and method for adjusting the confidence level of an output of a sensor according to at least an exemplary embodiment configured as described above are configured for determining suitability of the confidence levels of different types of sensors based on consistency between the different types of sensors and the driving environment of a vehicle and of readjusting the confidence levels of the different types of sensors based thereon, improving the performance and stability of a sensor fusion system.

However, the effects achievable through the present invention are not limited to the above-mentioned effects, and other effects not mentioned herein will be clearly understood by those skilled in the art from the above description.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A sensor output confidence level adjustment apparatus comprising:
a sensor information acquisition unit configured to acquire information on different types of sensors;
a sensor consistency determination unit configured to determine consistency between the different types of sensors according to the information on the different types of sensors;
a driving environment determination unit configured to determine a driving environment of a vehicle when the consistency between the different types of sensors is lower than a reference value; and
a confidence level adjustment unit configured to adjust confidence levels of the different types of sensors according to the consistency between the different types of sensors and the driving environment and to readjust the confidence levels of the different types of sensors according to the adjusted confidence levels.

2. The sensor output confidence level adjustment apparatus of claim 1,
wherein the sensor consistency determination unit is configured to classify reliabilities of the different types of sensors according to the information on the different types of sensors, including a recognition accuracy tendency and a recognition area depending on a type of sensor, the driving environment, and a situation of the vehicle, and to determine the consistency between the different types of sensors according to the reliabilities of the different types of sensors.

3. The sensor output confidence level adjustment apparatus of claim 1,
wherein, when determining the consistency between the different types of sensors, the sensor consistency determination unit is configured to classify relative reliabilities of the different types of sensors according to the information on the different types of sensors, and to determine consistency between a high-reliability sensor and a low-reliability sensor.

4. The sensor output confidence level adjustment apparatus of claim 1,
wherein, when determining the consistency between the different types of sensors, the sensor consistency determination unit is configured to determine the consistency between the different types of sensors based on location and speed information of a target.

5. The sensor output confidence level adjustment apparatus of claim 1,
wherein, when the consistency between the different types of sensors is lower than the reference value, the driving environment determination unit is configured to determine the driving environment based on preset conditions.

6. The sensor output confidence level adjustment apparatus of claim 5,
wherein the preset conditions include a first condition, a second condition, a third condition and a fourth condition, and
wherein the driving environment determination unit is configured to determine the driving environment according to the first condition of determining whether a location of a target output from a sensor corresponds to a boundary area of a field of view (FOV) of the sensor, the second condition of determining a degree of curvature of a road, the third condition of determining a heading, in degrees, of each of the target and the vehicle, and the fourth condition of determining whether an obstacle or a curb is present on the road.

7. The sensor output confidence level adjustment apparatus of claim 1,
wherein, when the consistency between the different types of sensors is higher than the reference value, the confidence level adjustment unit is configured to readjust a confidence level of an output of a low-reliability sensor to a same level as a confidence level of an output of a high-reliability sensor.

8. The sensor output confidence level adjustment apparatus of claim 1,
wherein, among factors of the driving environment, when the driving environment determination unit determines that a location of a target output from a low-reliability sensor corresponds to a boundary area of a field of view (FOV) of the low-reliability sensor, the confidence level adjustment unit is configured to readjust a confidence level of an output of the low-reliability sensor to a lower level.

9. The sensor output confidence level adjustment apparatus of claim 1,
wherein, among factors of the driving environment, when the driving environment determination unit determines that a location of a target output from a low-reliability sensor does not correspond to a boundary area of a field of view (FOV) of the low-reliability sensor and that a road environment is complicated, the confidence level adjustment unit is configured to readjust a confidence level of an output of the low-reliability sensor to a lower level.

10. The sensor output confidence level adjustment apparatus of claim 1,
wherein, among factors of the driving environment, when the driving environment determination unit determines that a location of a target output from a low-reliability sensor does not correspond to a boundary area of a field of view (FOV) of the low-reliability sensor and that a road environment is not complicated, the confidence level adjustment unit is configured to not readjust a confidence level of an output of the low-reliability sensor.

11. A sensor output confidence level adjustment method of a sensor output confidence level adjustment apparatus including a sensor information acquisition unit, a sensor consistency determination unit, a driving environment determination unit, and a confidence level adjustment unit, the sensor output confidence level adjustment method including:
acquiring, by the sensor information acquisition unit, information on different types of sensors;
determining, by the sensor consistency determination unit, consistency between the different types of sensors according to the information on the different types of sensors;
determining, by the driving environment determination unit, a driving environment when the sensor consistency determination unit determines that the consistency between the different types of sensors is lower than a reference value; and
adjusting, by the confidence level adjustment unit, confidence levels of the different types of sensors according to the consistency between the different types of sensors and the driving environment and readjusting the confidence levels of the different types of sensors according to the adjusted confidence levels.

12. The sensor output confidence level adjustment method of claim 11,
wherein the determining the consistency between the different types of sensors includes:
classifying reliabilities of the different types of sensors according to the information on the different types of sensors, including a recognition accuracy tendency and a recognition area depending on a type of sensor, the driving environment, and a situation of a vehicle; and
determining the consistency between the different types of sensors according to the reliabilities of the different types of sensors.

13. The sensor output confidence level adjustment method of claim 11,
wherein the determining the consistency between the different types of sensors includes:
classifying relative reliabilities of the different types of sensors according to the information on the different types of sensors; and
determining consistency between a high-reliability sensor and a low-reliability sensor.

14. The sensor output confidence level adjustment method of claim 11,
wherein the determining the consistency between the different types of sensors includes:
determining the consistency between the different types of sensors based on location and speed information of a target.

15. The sensor output confidence level adjustment method of claim 11,
wherein the readjusting the confidence levels of the different types of sensors includes:
when the consistency between the different types of sensors is higher than the reference value, readjusting a confidence level of an output of a low-reliability sensor to a same level as a confidence level of an output of a high-reliability sensor.

16. The sensor output confidence level adjustment method of claim 11,
wherein the readjusting the confidence levels of the different types of sensors includes:
among factors of the driving environment, when the driving environment determination unit determines that a location of a target output from a low-reliability sensor corresponds to a boundary area of a field of view (FOV) of the low-reliability sensor, readjusting a confidence level of an output of the low-reliability sensor to a lower level.

17. The sensor output confidence level adjustment method of claim 11,
wherein the readjusting the confidence levels of the different types of sensors includes:
among factors of the driving environment, when the driving environment determination unit determines that a location of a target output from a low-reliability sensor does not correspond to a boundary area of a field of view (FOV) of the low-reliability sensor and that a road environment is complicated, readjusting a confidence level of an output of the low-reliability sensor to a lower level.

18. The sensor output confidence level adjustment method of claim 11,
wherein the readjusting the confidence levels of the different types of sensors includes:
among factors of the driving environment, when the driving environment determination unit determines that a location of a target output from a low-reliability sensor does not correspond to a boundary area of a field of view (FOV) of the low-reliability sensor and that a road environment is not complicated, avoiding readjusting a confidence level of an output of the low-reliability sensor.

19. A non-transitory computer-readable recording medium in which a program configured to execute the method described in claim 11 is recorded.

20. A vehicle comprising:
different types of sensors configured to detect a driving environment of the vehicle; and
a sensor output confidence level adjustment apparatus configured to adjust confidence levels of the different types of sensors and to readjust the confidence levels of the different types of sensors,
wherein the sensor output confidence level adjustment apparatus is configured to acquire information on the different types of sensors, to determine consistency between the different types of sensors according to the information on the different types of sensors, to determine the driving environment when the sensor output confidence level adjustment apparatus concludes that the consistency between the different types of sensors is lower than a reference value, to adjust the confidence levels of the different types of sensors based on the consistency between the different types of sensors and the driving environment, and to readjust the confidence levels of the different types of sensors according to the adjusted confidence levels.
